(19) United States
(12) Patent Application Publication
(10) Pub. No.: US 2017/0085672 A1
(43) Pub. Date: Mar. 23, 2017

(54) Commercial-Interest-Weighted User Profiles

(71) Applicant: GOOGLE INC., (US)

(72) Inventors: Zhenzhen Liu, Santa Clara, CA (US); Shankar R. Ponnekanti, Mountain View, CA (US)

(73) Assignee: GOOGLE INC., Mountain View, CA (US)

(21) Appl. No.: 13/843,774

(22) Filed: Mar. 15, 2013

(51) Int. Cl. G06F 15/173

(52) U.S. Cl. CPC H04L 67/306

(57) ABSTRACT

Systems, methods performed by data processing apparatus and computer storage media encoded with computer programs for maintaining a user interest profile corresponding to a user and containing information describing visits to publisher sites (e.g., and/or individual pages within a site) over a predetermined period of time; analyzing each of the visited publisher sites in the particular user's interest profile to identify publisher sites that indicate a level of commercial interest; based on a result of the analyzing, assigning a commercial-interest weight value to each of the visited publisher sites such that publisher sites indicating higher levels of commercial interest receive higher commercial-interest weight values than publisher sites indicating lower levels of commercial interest; updating the particular user's interest profile based on the assigned commercial-interest weight values; and using the updated user interest profile to determine subsequent content items to be presented to the particular user when visiting publisher sites.

### BACKGROUND

This specification relates to providing digital content items (e.g., advertisements and/or other types of presentations) to users in a display environment.

Resource providers (e.g., publishers such as web site publishers) may include content such as sponsored content in their respective publications to help financially support their operations. Some resource providers do not maintain a content sponsoring (e.g., advertising) infrastructure, and thus depend on third party content sponsor serving companies to recruit content sponsors and to serve content items to the resource providers' sites. Third party content sponsor serving companies can, depending on various factors, control which content items are displayed to which users and under what circumstances. For example, a content sponsor serving company can provide directed content items, such as advertisements, to identified groups of users. Content items, such as advertisements, can be directed to the user by selecting suitable or appropriate content based on the user's user profile.

### SUMMARY

In general, one aspect of the subject matter described in this specification may be embodied in systems, methods performed by data processing apparatus and computer storage media encoded with computer programs that include the actions of maintaining a user interest profile corresponding to a particular user and containing information that describes visits to publisher sites (e.g., and/or individual pages within a site) over a predetermined period of time; analyzing each of the visited publisher sites in the particular user's interest profile to identify publisher sites that indicate a level of commercial interest; based on a result of the analyzing, assigning a commercial-interest weight value to each of the visited publisher sites such that publisher sites indicating higher levels of commercial interest receive higher commercial-interest weight values than publisher sites indicating lower levels of commercial interest; updating the particular user's interest profile based on the assigned commercial-interest weight values; and using the updated user interest profile to determine subsequent content items to be presented to the particular user when visiting publisher sites.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a diagram of an example network.

FIG. 2 is block diagram of an example of a commercial-interest page weight engine.

FIG. 3 is a flow chart of an example process of determining and using commercial-interest weights in connection with user interest profiles.

FIG. 4 is a block diagram of example computing devices that may be used to implement the systems and methods described in this document, as either a client or as a server or plurality of servers.

Like reference numbers and designations in the various drawings indicate like elements.

### DETAILED DESCRIPTION

The delivery of content (e.g., ads) in a content network to a particular user can be based on a current presentation page (e.g., webpage) that the user is visiting and/or on previous presentation pages that the user has visited. The content of the set of presentation pages visited by the user (or a portion thereof, as appropriate), along with the user's behavior relative to a displayed presentation page (e.g., clicking on a link or item of content), can be used to build a user interest profile for that particular user. Each user may have an associated user interest profile, which can be maintained at a central location (e.g., a server operated by a content serving entity) and/or on a local device associated with the user under consideration. In general, a user interest profile can be implemented as a collection of keywords (and/or other signals) that indicate or suggest topics or subject matter that may interest the associated user. Typically, each keyword has an associated value (e.g., ranging between 0-50) indicative of its relevance within the context of the presentation page in which it appears. In deciding which content to deliver to a user, a content serving entity may choose content that relates to keywords in that user's interest profile having higher values rather than keywords with lower values.

A particular user's user interest profile may be used, e.g., by a content serving entity to determine what ads and/or other content likely may interest a user and subsequently to deliver such content to the user with the hope and expectation that the user will express an interest in the served content, for example, by selecting or clicking on a content item, which in turn may result in the display of a presentation page associated with the served content item. As an example, assume that over a predetermined period of time a particular user has been visiting presentation pages that include keywords relating to outdoor recreational activities such camping, hiking, hunting and fishing. The keywords appearing on those pages may be collected, assigned respective values, and used to form, at least in part, the user's interest profile, which subsequently may be used in deciding which ads or other content items are to be displayed to the user when visiting presentation pages going forward. In the above example, a content sponsor serving entity may use the user's interest profile to cause ads from vendors selling goods or services relating to camping, hiking, etc. to be displayed to the user since, based on the user's interest profile, such ads are likely to be of interest to the user. By doing so, a potential expected outcome is that the user may click on one of the displayed ads and perhaps even continue one to consummate a sale (a process referred to as a “conversion”) on a presentation page associated with the vendor.

Some presentation pages—for example, the keywords and/or other signals appearing thereon—are more clearly indicative of a user's discernible interests than other presentation pages. For example, when a user visits a website or other presentation page associated with a specific vendor of goods/services, his or her interests are more easily discernible (namely, as relating to the nature of goods/services offered by that vendor) than when the user visits, e.g., a generic social network or news site. Moreover, a particular user's commercial interests (e.g., those interests that are relevant to the types of goods/services that the user is likely to purchase) may be more easily discernible from some types of presentation pages relative to other types of webpages. Accordingly, upon inferring a user's commercial interest from one or more presentation pages visited by the user—some of which have been determined to more clearly indicate the user's commercial interest than others—that information can be used as weighting factors to be applied to the corresponding presentation pages in the user's browsing history. The weighted presentation pages, in turn, may be used to build user interest profiles that are optimized to suggest ads or other content that are likely to appeal to the user's commercial interests. A potential advantage of using such commercial-interest-weighted user profiles is that content sponsors (e.g., advertisers) are more likely to realize improved conversion rates, click-through-rates (CTRs) and the like, thereby increasing the return-on-investment (ROI) spent on their advertising dollars.

In situations in which the systems discussed here collect information about users, or may make use of information about users, the users may be provided with an opportunity to control whether programs or features collect user information (e.g., information about a user's social network, social actions or activities, profession, a user's preferences, a user's current location, or a user's browsing history), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

### Example Operating Environment

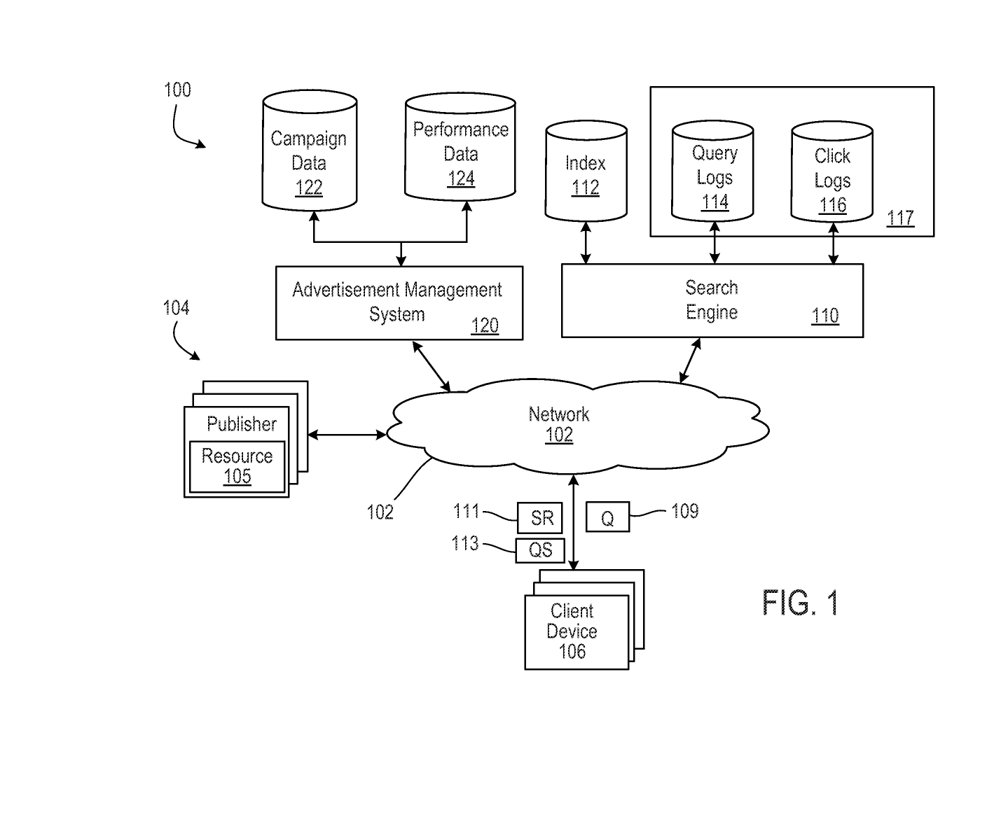

FIG. 1 is a block diagram of an example operating environment 100 in which various aspects of the subject matter described here may be implemented. A computer network 102, such as a local area network (LAN), wide area network (WAN), the Internet, or a combination thereof, connects resource provider web sites 104, user devices 106, and the search engine 110, and an advertisement management system 120. The online environment 100 may include many thousands of resource provider web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content resource provider, which is an entity that controls, manages and/or owns the website 104.

A resource is any data that can be provided by the resource provider 104 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as JAVASCRIPT scripts).

A user device 106 is an electronic device that is under the control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

To facilitate searching of these resources 105, the search engine 110 identifies the resources by crawling the resource provider web sites 104 and indexing the resources provided by the resource provider web sites 104. The indexed and, optionally, cached copies of the resources, are stored in an index 112.

The user devices 106 submit search queries 109 to the search engine 110. Alternatively, or in addition, the user devices 106 can interact directly with website 104 without going through the search engine 110. When the search engine 110 is employed, the search queries 109 are submitted in the form of a search request that includes the search request and, optionally, a unique identifier that identifies the user device 106 that submits the request. The unique identifier can be data from a cookie stored at the user device, or a user account identifier if the user maintains an account with the search engine 110, or some other identifier that identifies the user device 106 or the user using the user device.

In response to the search request, the search engine 110 uses the index 112 to identify resources that are relevant to the queries. The search engine 110 identifies the resources in the form of search results 111 and returns the search results to the user devices 106 in search results page resource. A search result is data generated by the search engine 110 that identifies a resource that satisfies a particular search query, and includes a resource locator for the resource. An example search result can include a web page title, a snippet of text extracted from the web page, and the URL of the web page.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device according to the order.

The user devices 106 receive the search results pages and render the pages for presentation to users. In response to the user selecting a search result at a user device 106, the user device 106 requests the resource identified by the resource locator included in the selected search result. The resource provider of the web site 104 hosting the resource receives the request for the resource from the user device 106 and provides the resource to the requesting user device 106.

In some implementations, the queries 109 submitted from user devices 106 are stored in query logs 114. Click data for the queries and the web pages referenced by the search results are stored in click logs 116. The query logs 114 and the click logs 116 define search history data 117 that include data from and related to previous search requests associated with unique identifiers. The click logs define actions taken responsive to search results provided by the search engine 110. The query logs 114 and click logs 116 can be used to map queries submitted by the user devices to web pages that were identified in search results and the actions taken by users (i.e., that data are associated with the identifiers from the search requests so that a search history for each identifier can be accessed). The click logs 116 and query logs 114 can thus be used by the search engine to determine the sequence of queries submitted by the user devices, the actions taken in response to the queries, and how often the queries are submitted.

The advertisement management system 120 facilitates the provisioning of content items with the resources 105. In particular, the advertisement management system 120 allows content sponsors to define rules that take into account attributes of the particular user to provide customized content items for the users. Example rules include keyword customization, in which content sponsor provide bids for keywords that are present in either search queries or webpage content. Content items that are associated with keywords having bids that result in an advertisement slot being awarded in response to an auction are selected for displaying in the advertisement slots.

When a user of a user device 106 selects an advertisement, the user device 106 generates a request for a landing page of the advertisement, which is typically a webpage of the content sponsor. For example, the resource providers 104 may include content sponsors, each having hosting respective web pages, some of which are landing pages for the content items of the content sponsors.

These customized content items can be provided for many different resources, such as the resources 105 of the resource providers 104, and on a search results page resource. For example, a resource 105 from a resource provider 104 includes instructions that cause the user device to request content items from the advertisement management system 120. The request includes a resource provider identifier and, optionally, keyword identifiers related to the content of the resource 105. The advertisement management system 120, in turn, provides customized content items to the particular user device.

With respect to a search results page, the user device 106 renders the search results page and sends a request to the advertisement management system 120, potentially along with one or more keywords related to the query that the user provide to the search engine 110. Alternatively, or in addition, the advertisement management system 120 generates one or more keywords by parsing the content of the request URL. In any event, the advertisement management system 120, in turn, provides customized content items to the particular user device.

The advertisement management system 120 includes a data storage system that stores campaign data 122 and performance data 124. The campaign data 122 stores content items, customization information, and budgeting information for content sponsors. The performance data 124 stores data indicating the performance of the content items that are served. Such performance data can include, for example, click through rates for content items, the number of impressions for content items, and the number of conversions for content items. Other performance data can also be stored.

The campaign data 122 and the performance data 124 are used as input parameters to an advertisement auction. In particular, the advertisement management system 120, in response to each request for content items, conducts an auction to select content items that are provided in response to the request. The content items are ranked according to a score that, in some implementations, is proportional to a value based on an advertisement bid and one or more parameters specified in the performance data 124. The highest ranked content items resulting from the auction are selected and provided to the requesting user device.

### Commercial-Interest-Weighted User Profiles

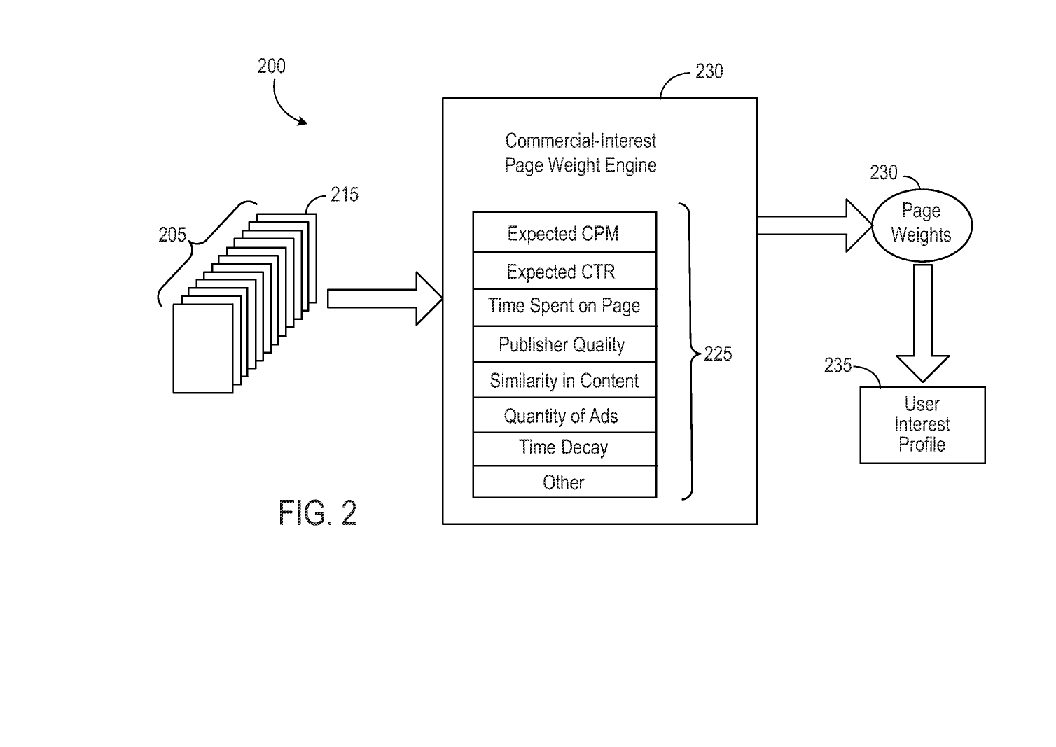

FIG. 2 is a block diagram 200 of commercial-interest weight calculation engine 200, which may be used to determine a commercial-interest weight for each of the presentation pages 205 visited or otherwise viewed by a user. As shown, each of the pages 205 visited by a user over a predetermined period of time (e.g., 30 minutes) is analyzed by the engine 220 and assigned a corresponding commercial-interest weight 230. In this example, the oldest page 215 is analyzed and weighted first while the page immediately preceding the most recent page 210 is analyzed and weighted last, although a different ordering could be used. The most recent page 210 (i.e., the current page) is not analyzed and weighted, rather the user interest profile is generated from past pages. For example, when the user is on the current page 210, his/her user profile is derived only from the preceding pages—that is, only from those past pages are the commercial weights computed.

Each page's respective commercial-interest weight, which represents the likelihood that the page under consideration is indicative of the commercial-interests of the particular user that visited the page, may be calculated by the engine 220 using one or more factors 225. The factors, described in more detail below may include (1) the page's expected revenue; (2) the page's expected CTR (Click-Through-Rate); (3) the duration of time that the user spent on the page under consideration; (4) the page's publisher quality; (5) the quantity of ads and/or other content items that were determined to be available for display on the page under consideration; (6) the similarity between the page under consideration and the most recent page 210; (7) the time decay (e.g., time lapse) between display of the page under consideration and the most recent page 210; and (8) any other suitable factor tending to indicate the likelihood that the page under consideration is indicative of the user's commercial interests.

(1) Page's Expected Revenue—this factor relates to the expected amount of revenue that is generated by the page under consideration, the underlying logic being that a page having a higher expected revenue is more likely to be commercial in nature—and thus more likely to be indicative of the user' commercial interests—than a page having a lower expected revenue. A page's expected revenue may be calculated, for example, by summing the respective CPM (Cost-Per-Mille or, equivalently, cost per thousand impressions) for each of the ads displayed on the page. To determine a value of this factor to be used by the engine 220, the range of expected revenues can be bucketized into percentiles. For example, a page having relatively high expected revenue may fall into the 90^{th} percentile of expected revenue values, meaning that the engine 220 would use 0.9 as the factor value corresponding to the page's expected revenue.

(2) Page's Expected CTR—this factor relates to the historical rate, as extracted from the logs, that users clicked on one of the ads displayed on the page under consideration, the underlying logic being that a page having a higher CTR is more likely to be commercial in nature—and thus more likely to be indicative of the user' commercial interests—than a page having a lower CTR. CTR values fall between zero and one.

(3) Time Spent on Page—this factor relates to the duration of time (e.g., measured in seconds) that the user spent on the page under consideration, the underlying logic being that a page on which a user lingered for a relatively long time is more likely to be of interest to the user.

(4) Page's Publisher Quality—this factor relates to the historical rate, as extracted from the logs, that an impression of the page resulted in a conversion, for example, by a user clicking on a displayed ad and then following up to consummate a commercial transaction (e.g., a purchase) with the associated advertiser or vendor, the underlying logic being that a page having a higher conversion rate is more likely to be commercial in nature—and thus more likely to be indicative of the user' commercial interests—than a page having a lower conversion rate. Publisher quality values fall between zero and one.

(5) Quantity of Ads—this factor relates to the quantity of ads that, based on the advertisers' respective criteria, were available to be displayed on the page under consideration, the underlying logic being that a page having a relatively high number of potentially available ads for display is more likely to be commercial in nature—and thus more likely to be indicative of the user' commercial interests—than a page having a lower number of potentially available ads for display. Quantity of ads values are positive, whole numbers.

(6) Similarity in Content—this factor relates to the degree of similarity between the page under consideration and the most recent page, the underlying logic being that the most recent page more accurately reflects the user's current or most recent interests, and this a page having a relatively high degree of similarity with the most recent page also is likely to accurately reflect the user's current interests. The similarity in content factor may be calculated using a cosine similarity function, with output values ranging from zero (no detected similarity) to one (virtual identity).

(7) Time Decay—this factor relates to the duration of time (e.g., measured in seconds) that lapsed between the user's visiting the page under consideration and the user's visiting the most recent page, the logic being that the longer the duration the less likely that the page under consideration accurately represents the user's current interests.

The commercial-interest page weight engine 220 uses one or more of the above-described factors to calculate page weights 230, that is, a separate page weight for each individual page 205 that was analyzed (i.e., not including current page 210). Once all of the page weights have been calculated for the pages 205, the resulting values may be normalized to cause them all to fall between zero and one. The normalized page weights 230 may then be associated with their respective corresponding pages and used to generate, or update, the user's user interest profile 235. This may be accomplished, for example, by multiplying each of the page's keyword values by the commercial weight for the page. For example, assume that, prior to modifying the user interest profile 235 to account for the commercial weight of the page, the user interest profile 235 included information describing a particular page (e.g., Page X) visited by the user along with an indication of, e.g., three keywords appearing on Page X having example normalized values of 0.90, 0.70, and 0.20, respectively. Assume further that the engine 220 calculates that Page X has a normalized commercial-interest weight of 0.5. Accordingly, to account for Page X's calculated commercial interest weight, the values of each of the keywords associated with Page X would be multiplied by 0.5, thereby causing the keyword values of Page X to be modified to 0.45, 0.35, and 0.10, respectively. Similarly, for a page determined to have zero likelihood of indicating a user's commercial interest, the corresponding calculated commercial interest weight for that page may be zero, thereby causing the keyword values for that page in the user interest profile also to be modified to zero. Conversely, for a page determined to have among the highest likelihood of indicating a user's commercial interest, the corresponding calculate commercial interest weight for that page may be one, thereby causing the keyword values in the user interest profile for that page to remain unaffected.

In this manner, user interest profile keywords appearing on pages having a lower likelihood of being indicative of a user's commercial interest will have a proportionately smaller effect, if any, on the choice of ads and/or other content items to be presented to the user on current and/or future pages. Conversely, user interest profile keywords appearing on pages having a high likelihood of being indicative of a user's commercial interest will have a proportionately larger effect on the choice of ads and/or other content items to be presented to the user on current and/or future pages.

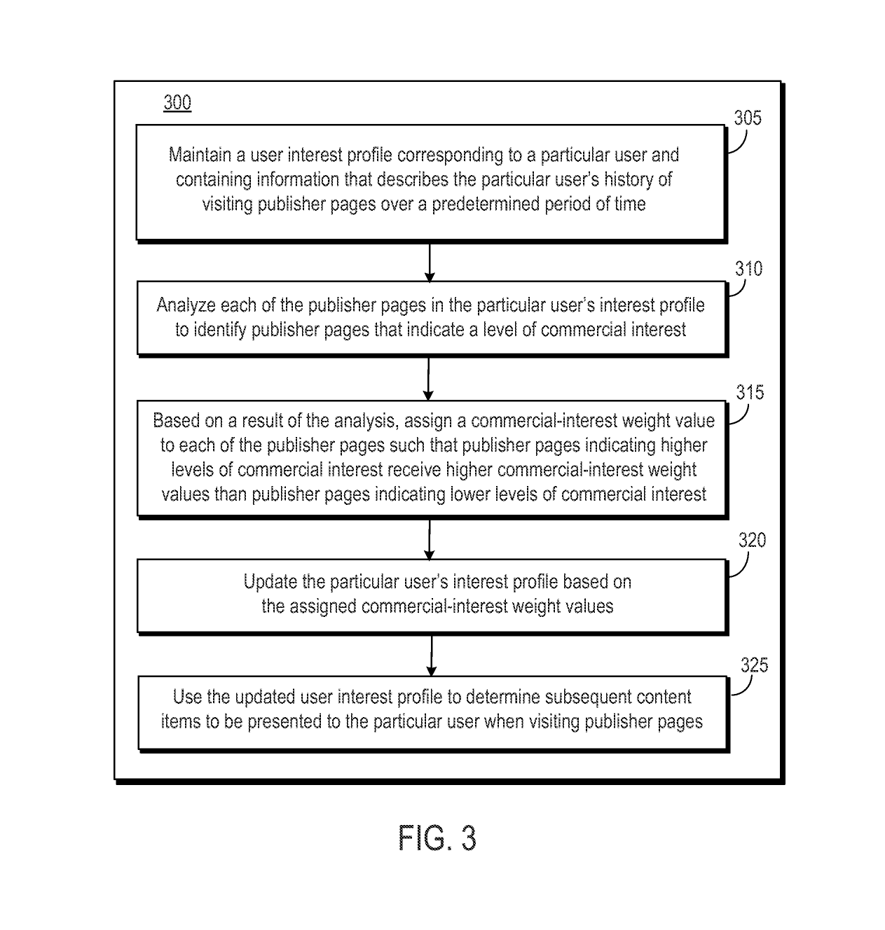

FIG. 3 is a flow chart of an example process 300 of determining and using commercial-interest weights in connection with user interest profiles. At 305, the process 300 maintains a user interest profile corresponding to a particular user and containing information (e.g., keywords along with an identification of the publisher page on which the respective keywords appeared) that describes the particular user's history of visiting publisher pages over a predetermined period of time (e.g., the last 30 minutes). Next, at 310, the process 300 analyzes each of the publisher pages in the particular user's interest profile to identify publisher pages that indicate a level of commercial interest.

At 315, based on a result of the analyzing, the process 300 assigns a commercial-interest weight value to each of the publisher pages using, e.g., one or more factors including the page's expected revenue, the page's expected CTR, the duration of time that the user spent on the page under consideration, the page's publisher quality, the quantity of ads and/or other content items that were determined to be available for display on the page under consideration, the similarity between the page under consideration and the most recent page, and/or the time decay (e.g., time lapse) between display of the page under consideration and the most recent page. In general, publisher pages indicating higher levels of commercial interest receive higher commercial-interest weight values than publisher pages indicating lower levels of commercial interest.

At 320, the process 300 updates the particular user's interest profile based on the assigned commercial-interest weight values, e.g., by adjusting the respective values of the keywords associated with a page using that page's commercial-interest weight value. At 325, the process 300 uses the updated user interest profile to determine subsequent content items to be presented to the particular user when visiting publisher pages.

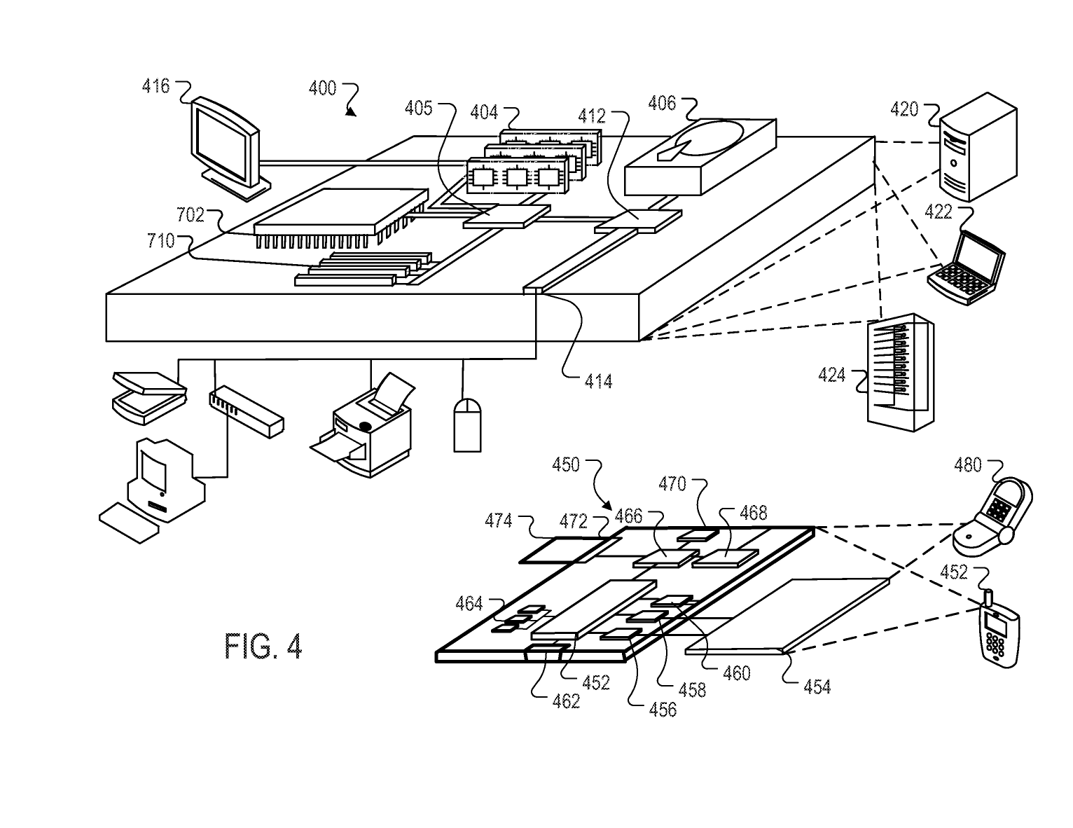

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. Additionally computing device 400 or 450 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452 that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for detecting impersonation on a social network may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A method performed by one or more data processing apparatus, the method comprising:
maintaining a user interest profile corresponding to a particular user and containing information that i) describes visits to publisher sites over a predetermined period of time and ii) one or more keywords associated with each visited publisher site, the keywords having, for each visited publisher site, an associated relevance value indicative of a relevance to the publisher site;
analyzing each of the visited publisher sites in the particular user's interest profile, the analyzing comprising, for each of the visited publisher sites:
i) identifying a quantity of advertisements displayed on the visited publisher site, the advertisements associated with advertisement criteria for the visited publisher site, the quantity of advertisements indicating a likelihood that the visited publisher site is indicative of a commercial-interest by the particular user in a given set of goods or services,
ii) applying a cosine similarity function to content of the visited publisher site and to content of another visited publisher site to determine a similarity content factor between the visited publisher site and the another visited publisher site, the another visited publisher site being a most recently visited publisher site prior to the visited publisher site, and
iii) calculating a page weight for the visited publisher site based on a) the identified quantity of advertisements displayed on the visited publisher site and b) the similarity content factor between the visited publisher site and the another visited publisher site;
assigning a commercial-interest weight value to each of the visited publisher sites based on the calculated page weight for each of the visited publisher sites such that publisher sites indicating higher levels of commercial interest receive higher commercial-interest weight values than publisher sites indicating lower levels of commercial interest;
updating the particular user's interest profile based on the assigned commercial-interest weight values, the updating including adjusting respective values of a particular site's keywords using the particular site's assigned commercial-interest weight value;
receiving a request for content to be presented on an additional publisher site currently being visited by the particular user; and
determining subsequent content items to be presented to the particular user on the additional publisher site using the updated user interest profile rather than content of the additional publisher site.

2. The method of claim 1 wherein the analyzing further comprises calculating the page weight for each of the visited publisher sites based further on an expected revenue associated with the site.

3. The method of claim 1 wherein the analyzing further comprises calculating the page weight for each of the visited publisher sites based further on an expected click-through-rate associated with the site.

4. The method of claim 1 wherein the analyzing further comprises calculating the page weight for each of the visited publisher sites based further on a duration of time that a user spent on the site.

5. The method of claim 1 wherein the analyzing comprises calculating the page weight for each of the visited publisher sites based further on a publisher quality associated with the site.

6. (canceled)

7. (canceled)

8. The method of claim 1 wherein the analyzing comprises calculating the page weight for each of the visited publisher sites based further on a time lapse between display of the site and the most recent site.

9. The method of claim 1 wherein the assigned commercial-interest weight values are normalized values between zero and one.

10. The method of claim 1 wherein the maintained user interest profile comprises a history of publisher sites visited by the particular user.

11. (canceled)

12. A system comprising:
a processor configured to execute computer program instructions; and
a computer storage medium encoded with computer program instructions that are executed by the processor to cause the system to perform operations comprising:
maintain a user interest profile corresponding to a particular user and containing information that i) describes visits to publisher sites over a predetermined period of time and ii) one or more keywords associated with each visited publisher site, the keywords having an associated relevance value;
analyze each of the visited publisher sites in the particular user's interest profile, the analysis comprising, for each of the visited publisher sites:
i) identify a quantity of advertisements displayed on the visited publisher site, the advertisements associated with advertisement criteria for the visited publisher site, the quantity of advertisements indicating a likelihood that the visited publisher site is indicative of a commercial-interest by the particular user in a given set of goods or services,
ii) apply a cosine similarity function to content of the visited publisher site and to content of another visited publisher site to determine a similarity content factor between the visited publisher site and the another visited publisher site, the another visited publisher site being a most recently visited publisher site prior to the visited publisher site, and
iii) calculate a page weight for the visited publisher site based on a) the identified quantity of advertisements displayed on the visited publisher site and b) the similarity content factor between the visited publisher and the another visited publisher site;
assign a commercial-interest weight value to each of the visited publisher sites based on the calculated page weight for each of the visited publisher sites such that publisher sites indicating higher levels of commercial interest receive higher commercial-interest weight values than publisher sites indicating lower levels of commercial interest;
update the particular user's interest profile based on the assigned commercial-interest weight values, the updating including adjusting respective values of a particular site's keywords using the particular site's assigned commercial-interest weight value;
receive a request for content to be presented on an additional publisher site currently being visited by the particular user; and
determine subsequent content items to be presented to the particular user on the additional publisher site using the updated user interest profile rather than content of the additional publisher site.

13. The system of claim 12 wherein the analysis further comprises calculating the page weight for each of the visited publisher sites based further on an expected revenue associated with the site.

14. The system of claim 12 wherein the analysis further comprises calculating the page weight for each of the visited publisher sites based further on an expected click-through-rate associated with the site.

15. The system of claim 12 wherein the analysis further comprises calculating the page weight for each of the visited publisher sites based further on a duration of time that a user spent on the site.

16. The system of claim 12 wherein the analysis further comprises calculating the page weight for each of the visited publisher sites based further on a publisher quality associated with the site.

17. (canceled)

18. (canceled)

19. The system of claim 12 wherein the analysis further comprises calculating the page weight for each of the visited publisher sites based further on a time lapse between display of the site and the most recent site.

20. The system of claim 12 wherein the maintained user interest profile comprises a history of publisher sites visited by the particular user.
